(19) United States
(12) Patent Application Publication
(10) Pub. No.: US 2025/0314305 A1
(43) Pub. Date: Oct. 9, 2025

(54) VALVE SEAT ASSEMBLY

(71) Applicant: GD Energy Products, LLC, Tulsa, OK (US)

(72) Inventors: Troy Edward Wiegand, Fort Worth, TX (US); James Robert Yanus, Tulsa, OK (US); Jason Lee Mayo, West Odessa, TX (US); Gregory Vincent Protz, Midland, TX (US)

(21) Appl. No.: 19/244,841

(22) Filed: Jun. 20, 2025

Related U.S. Application Data
(63) Continuation-in-part of application No. 18/751,402, filed on Jun. 24, 2024.
Application No. 18/751,402 is a continuation of application No. 18/164,343, filed on Feb. 3, 2023, now Pat. No. 12,018,759.
(60) Provisional application No. 63/662,642, filed on Jun. 21, 2024.
(60) Provisional application No. 63/662,648, filed on Jun. 21, 2024.

(51) Int. Cl. F16K 1/42; F16K 25/00

(52) U.S. Cl. CPC F16K 1/42; F16K 25/005

(57) ABSTRACT

A valve seat assembly utilized in a fluid end assembly of a reciprocating pump may contain a strike ring and a support sleeve. The support sleeve and the strike ring are disposed in a bore in a fluid end casing with the strike ring engaging the support sleeve via a mating feature or joint.

### CROSS-REFERENCE TO PRIOR APPLICATIONS

This is a continuation in part of U.S. patent application Ser. No. 18/751,402, entitled “VALVE SEAT ASSEMBLY,” filed Jun. 24, 2024, which is a continuation of U.S. patent application Ser. No. 18/164,343, entitled “VALVE SEAT ASSEMBLY,” filed Feb. 3, 2023. This patent application also claims priority to and the benefit of U.S. Provisional Patent Application No. 63/662,642, entitled “VALVE SEAT ASSEMBLY,” filed Jun. 21, 2024, and U.S. Provisional Patent Application No. 63/662,648, entitled “VALVE SEAT ASSEMBLY,” filed Jun. 21, 2024 .The disclosures of the above-identified U.S. patent applications are hereby incorporated by reference in their entireties for all purposes.

### FIELD OF THE INVENTION

The present invention relates to the field of high pressure reciprocating pumps and, in particular, to the valves and/or valve seats utilized in the fluid ends of high pressure reciprocating pumps.

### BACKGROUND OF THE INVENTION

High pressure reciprocating pumps are often used to deliver high pressure fluids during earth drilling operations. One or more sealing arrangements are typically provided in the fluid end of a pump to seal conduits formed in the fluid end and prevent, or at least discourage, leakage. More specifically, the fluid end may define an internal chamber and one or more conduits may define pathways between the internal chamber and one or more external surfaces of the fluid end. At least some segments of these conduits may be sealed with a sealing assembly (e.g., a cover, plug, and/or sleeve) that includes or defines one or more seals. Additionally, or alternatively, some of the segments may include valves or valve components that include or define one or more seals in conjunction with corresponding valve seats. These seals may prevent, or at least discourage, leakage through the conduits.

The high pressures experienced by these reciprocating pumps result in component failures that are not typically seen or experienced with pumps that operate at lower pressures. Typical failures may include erosion or wearing of the valve seat. This may be accelerated due to the forces exerted by and onto the valve seat when a valve strike surface/sealing face is compressed against the valve seat. The higher the pressures experienced by the reciprocating pumps, the faster the valve seats are eroded. When the valve seat fails, leakages occur around the valve, which ultimately reduces the maximum pressure and flow capabilities of the pump.

### SUMMARY

The present application relates to techniques for sealing a segment of a fluid end of a high pressure reciprocating pump. The techniques may be embodied as a valve component and/or a sealing assembly that is provided independent of any other elements or that is incorporated in a fluid end, e.g., as part of a kit, as part of a fluid end, and/or as part of a reciprocating pump.

In one embodiment, the invention relates to a valve seat assembly for a reciprocating pump with the valve seat assembly including a strike ring having a first body and a support sleeve having a second body. The first body of the strike ring has a first end surface, a second end surface opposite the first end surface, and a first outer surface. The second body of the support sleeve has a third end surface, a fourth end surface opposite the third end surface, and a second outer surface having a different configuration than the first outer surface. Moreover, the second end surface of the first body includes a first mating feature configured to mate with a second mating feature of the third end surface of the second body.

As an example, the first mating feature may be one of a wedge or a groove and the second mating surface may be an other of the wedge and the groove. In at least some instances, the wedge and groove may form a thermal wedge lock when mated with each other. As another example, the first mating feature may be one of a convex surface or a concave surface and the second mating surface may be an other of the convex surface or the concave surface.

In at least one embodiment, the strike ring is constructed from a carbide material and the support sleeve is constructed from steel. Alternatively, the support sleeve may be constructed from a first material with a first hardness and the strike ring may be constructed from a second material that has a second hardness that is harder than the hardness of the strike ring. For example, the support sleeve may be formed from a first steel formulation and the strike ring may be formed from a different, harder steel formulation.

Additionally or alternatively, the first end surface of the strike ring may be angled with respect to the first outer surface and form at least a portion of a strike surface of the strike ring. In fact, in some embodiments, the first body of the strike ring may have a first inner surface that defines a first bore, and the first end surface is a strike surface that is oriented at an angle relative to the first inner surface. In either instance, the angle of the first end surface may be approximately 30 degrees. Still further, the second body of the support sleeve may include a second inner surface defining a second bore. In some of these embodiments, the first body defines a first bore therethrough, the second body defines a second bore therethrough, and the first bore is aligned with the second bore when the first body is proximate to the second body. Such alignment may occur when the strike ring sits in a support seat defined by the support sleeve and/or when the strike ring mates with the support sleeve. However, in other embodiments, the strike ring is radially spaced from the circumference of the second bore and only the second bore of the support sleeve defines a bore through the valve seat.

In another embodiment, the invention relates to a method of manufacturing a valve seat assembly of any of the embodiments described above or herein.

In yet another embodiment, the invention relates to a valve assembly for a fluid end of a reciprocating pump. The valve assembly includes a valve component and a valve seat formed in accordance with any of the embodiments described above or herein.

### BRIEF DESCRIPTION OF THE DRAWINGS

The apparatuses, systems, devices, modules, valve components, valve seats, seals, and/or sealing elements presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts throughout the different views.

FIG. 1 is a perspective view of a prior art reciprocating pump including a fluid end.

FIG. 2 is a cross-sectional side view of another prior art fluid end.

FIG. 3 illustrates a perspective view of a prior art valve component that may be utilized in the fluid ends illustrated in FIGS. 1 and 2.

FIG. 4 illustrates a perspective view of the prior art valve component illustrated in FIG. 3 being inserted into a corresponding prior art valve seat to form a sealing arrangement.

FIG. 5 illustrates a cross-sectional side view of a prior art fluid end including prior art valve seat assemblies.

FIG. 6 illustrates a cross-sectional view of a prior art fluid end including prior art valve seat assemblies and prior art valve components.

FIG. 7 illustrates a schematic cross-sectional view of a first embodiment of a valve seat assembly according to the present invention.

FIG. 8 illustrates a schematic, partial cross-sectional view of a second embodiment of a valve seat assembly according to the present invention, the second embodiment being a variant of the first embodiment.

FIG. 9 illustrates a schematic cross-sectional view of a third embodiment of a valve seat assembly according to the present invention.

FIG. 10 illustrates a schematic, partial cross-sectional view of a fourth embodiment of a valve seat assembly according to the present invention, the fourth embodiment being a variant of the third embodiment.

FIG. 11 illustrates a schematic cross-sectional view of a fifth embodiment of a valve seat assembly according to the present invention.

FIGS. 12-14 illustrate schematic, partial cross-sectional views of further embodiments of a valve seat assembly according to the present invention, the further embodiments being variants of the fifth embodiment.

FIG. 15 illustrates a schematic cross-sectional view of a sixth embodiment of a valve seat assembly according to the present invention.

FIG. 16 illustrates a partially exploded view of the valve seat assembly of FIG. 15.

FIG. 17 illustrates a schematic cross-sectional view of a seventh embodiment of a valve seat assembly according to the present invention.

FIG. 18 illustrates a flowchart of a method of manufacture of a fluid end according to the present invention.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment.

Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Also, the terms “comprising,” “including,” “having,” and the like, as used with respect to embodiments of the present disclosure, are synonymous.

Embodiments disclosed herein are directed to a valve seat assembly configured to be implemented in a fluid end of a reciprocating pump. In particular, the valve seat assembly includes a support sleeve configured to engage with a fluid end casing of the fluid end, such as by inserting into a bore defined by the fluid end casing. The valve seat assembly also includes a strike ring configured to couple to the support sleeve. As an example, the support sleeve and the strike ring may have corresponding mating features configured to mate with one another to couple the support sleeve and the strike ring to one another.

The strike ring is configured to engage with a valve to block fluid flow through the bore of the fluid end casing. Specifically, during operation of the reciprocating pump, the valve may repeatedly move into and out of contact with the strike ring to selectively enable and block fluid flow through the bore. The strike ring is composed of a sufficiently hard material, such as tungsten carbide, to withstand repeated impact with the valve. Thus, the strike ring is resistant to wear.

Meanwhile, the support sleeve is composed of a relatively softer and/or relatively less expensive material. The strike ring covers a surface of the support sleeve to block exposure of the surface to the valve. That is, the strike ring blocks the surface of the support sleeve from contacting the valve, thereby reducing wear of the support sleeve. Additionally, the support sleeve is configured to block the strike ring from contacting a substantial portion of the fluid end casing. For this reason, the support sleeve is configured to block or blunt force transferred from the strike ring (e.g., as a result of impact with the valve) to the fluid end casing. Therefore, the support sleeve may reduce wear of the fluid end casing that otherwise can be caused by the relatively harder material of the strike ring contacting and/or abrading against the fluid end casing. Consequently, the valve seat assembly disclosed herein may increase a useful lifespan and maintain desirable operation of the reciprocating pump.

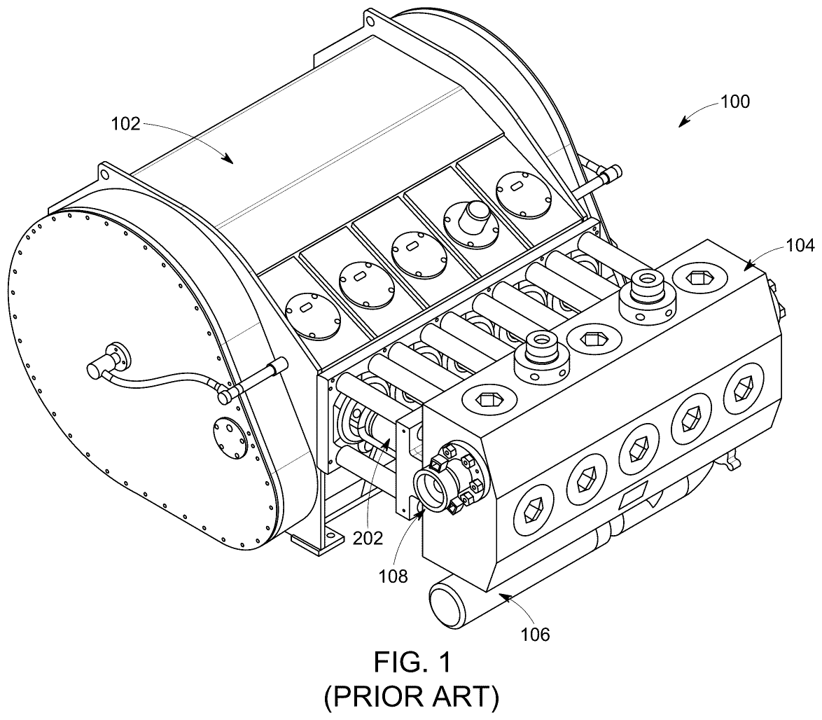

Referring to FIG. 1, a prior art reciprocating pump 100 is illustrated. The reciprocating pump 100 includes a power end 102 and a fluid end 104. The power end 102 includes a crankshaft that drives a plurality of reciprocating plungers within the fluid end 104 to pump fluid at high pressure. Generally, the power end 102 is capable of generating forces sufficient to cause the fluid end 104 to deliver high pressure fluids to earth drilling operations. For example, the power end 102 may be configured to support hydraulic fracturing (i.e., fracking) operations, where fracking liquid (e.g., a mixture of water and sand) is injected into rock formations at high pressures to allow natural oil and gas to be extracted from the rock formations. However, to be clear, this example is not intended to be limiting and the present application may be applicable to both fracking and drilling operations.

Often, the reciprocating pump 100 may be quite large and may, for example, be supported by a semi-tractor truck (“semi”) that can move the reciprocating pump 100 to and from a well. Specifically, in some instances, a semi may move the reciprocating pump 100 off a well when the reciprocating pump 100 requires maintenance. However, a reciprocating pump 100 is typically moved off a well only when a replacement pump (and an associated semi) is available to move into place at the well, which may be rare. Thus, often, the reciprocating pump is taken offline at a well and maintenance is performed while the reciprocating pump 100 remains on the well. If not for this maintenance, the reciprocating pump 100 could operate continuously to extract natural oil and gas (or conduct any other operation). Consequently, any improvements that extend the lifespan of components of the reciprocating pump 100, especially typical “wear” components, and extend the time between maintenance operations (i.e., between downtime) are highly desirable.

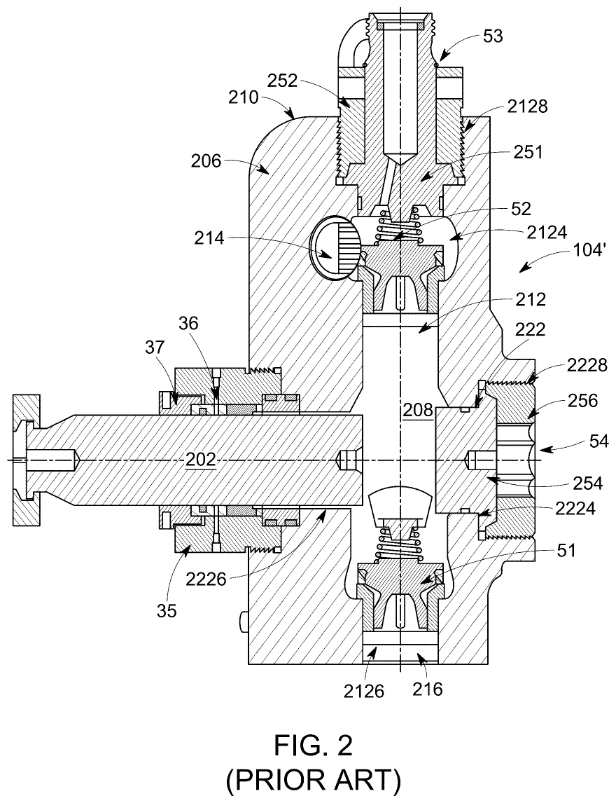

Still referring to FIG. 1, but now in combination with FIG. 2, in various embodiments, the fluid end 104 may be shaped differently and/or have different features, but may still generally perform the same functions, define similar structures, and house similar components. To illustrate potential shape variations, FIG. 2 shows a side, cross-sectional view of a fluid end 104′ with different internal and external shaping as compared to fluid end 104. However, since fluid end 104 and fluid end 104′ have many operational similarities, FIGS. 1 and 2 are labeled with the same reference numerals and are both described with respect to these common reference labels.

The view illustrated in FIG. 2 is taken along a central or plunger axis of one of the plungers 202 included in a reciprocating pump 100. Thus, although FIG. 2 illustrates a single pumping chamber 208, it should be understood that a fluid end 104 can include multiple pumping chambers 208 arranged side-by-side. In fact, in at least some embodiments (e.g., the embodiment of FIG. 1), a casing 206 of the fluid end 104 forms a plurality of pumping chambers 208 and each chamber 208 includes a plunger 202 that reciprocates within the casing 206. However, side-by-side pumping chambers 208 need not be defined by a single casing 206. For example, in some embodiments, the fluid end 104 may be modular and different casing segments may house one or more pumping chambers 208. In any case, the one or more pumping chambers 208 are arranged side-by-side so that corresponding conduits are positioned adjacent each other and generate substantially parallel pumping action. Specifically, with each stroke of the plunger 202, low pressure fluid is drawn into the pumping chamber 208 and high pressure fluid is discharged. But, often, the fluid within the pumping chamber 208 contains abrasive material (i.e., “debris”) that can damage seals formed in the reciprocating pump 100.

As can be seen in FIG. 2, the pumping paths and pumping chamber 208 of the fluid end 104′ are formed by conduits that extend through the casing 206 to define openings at an external surface 210 of the casing 206. More specifically, a first conduit 212 extends longitudinally (e.g., vertically) through the casing 206 while a second conduit 222 extends laterally (e.g., horizontally) through the casing 206. Thus, conduit 212 intersects conduit 222 to at least partially (and collectively) define the pumping chamber 208. In the prior art fluid end 104 and prior art fluid end 104′, conduits 212 and 222 are substantially cylindrical, but the diameters of conduit 212 and conduit 222 may vary throughout the casing 206 so that conduits 212 and 222 can receive various structures, such as sealing assemblies or components thereof.

Regardless of the diameters of conduit 212 and conduit 222, each conduit may include two segments, each of which extend from the pumping chamber 208 to the external surface 210 of the casing 206. Specifically, conduit 212 includes a first segment 2124 and a second segment 2126 that opposes the first segment 2124. Likewise, conduit 222 includes a third segment 2224 and a fourth segment 2226 that opposes the third segment 2224. In the illustrated embodiment, the segments of a conduit (e.g., segments 2124 and 2126 or segments 2224 and 2226) are substantially coaxial while the segments of different conduits are substantially orthogonal. However, in other embodiments, segments 2124, 2126, 2224, and 2226 may be arranged along any desired angle or angles, for example, to intersect pumping chamber 208 at one or more non-straight angles.

In the illustrated embodiment, conduit 212 defines a fluid path through the fluid end 104. The second segment 2126 is an intake segment that connects the pumping chamber 208 to a piping system 106 (as illustrated in FIG. 1) delivering fluid to the fluid end 104. Meanwhile, the first segment 2124 is an outlet or discharge segment that allows compressed fluid to exit the fluid end 104′. Thus, in operation, segments 2126 and 2124 may include valve components 51 and 52, respectively, (e.g., one-way valves) that allow segments 2126 and 2124 to selectively open. Typically, valve components 51 in the second segment 2126 may be secured therein by the piping system 106. Meanwhile valve components 52 in the first segment 2124 may be secured therein by a closure assembly 53 that, in the prior art example shown in FIG. 2, includes a closure element 251 (also referred to as a discharge plug) that is secured in the first segment 2124 by a retaining assembly 252. Specifically, the prior art retaining assembly 252 is coupled to the first segment 2124 via threads 2128 defined by an interior wall of the first segment 2124.

On the other hand, the fourth segment 2226 defines, at least in part, a cylinder for plunger 202, and/or connects the casing 206 to a cylinder for plunger 202. For example, in the illustrated embodiment, a casing segment 35 is secured to the fourth segment 2226 and houses a packing assembly 36 configured to seal against a plunger 202 disposed interiorly of the packing assembly 36. In any case, reciprocation of a plunger 202 in or adjacent to the fourth segment 2226, which may be referred to as a reciprocation segment, draws fluid into the pumping chamber 208 via the second segment 2126 and pumps the fluid out of the pumping chamber 208 via the first segment 2124. Notably, in the illustrated prior art arrangement, the packing assembly 36 is retained within casing segment 35 with a retaining element 37 that is threadably coupled to casing segment 35.

The third segment 2224 is an access segment that can be opened to access to parts disposed within casing 206 and/or surfaces defined within casing 206. During operation, the third segment 2224 may be closed by a closure assembly 54 that, in the prior art example illustrated in FIG. 2, includes a closure element 254 (also referred to as a suction plug) that is secured in the third segment 2224 by a retaining assembly 256. Notably, the prior art retaining assembly 256 is coupled to the third segment 2224 via threads 2228 defined by an interior wall of the third segment 2224. However, in some embodiments, conduit 222 need not include the third segment 2224 and conduit 222 may be formed from a single segment (e.g., the fourth segment 2226) that extends from the pumping chamber 208 to the external surface 210 of casing 206.

Overall, in operation, fluid may enter fluid end 104 (or fluid end 104′) via multiple openings, as represented by opening 216 in FIG. 2, and exit fluid end 104 (or fluid end 104′) via multiple openings, as represented by opening 214 in FIG. 2. In at least some embodiments, fluid enters openings 216 via pipes of piping system 106, flows through pumping chamber 208 (due to reciprocation of a plunger 202), and then flows through openings 214 into a channel 108 (see FIG. 1). However, piping system 106 and channel 108 are merely example conduits and, in various embodiments, fluid end 104 may receive and discharge fluid via any number of pipes and/or conduits, along pathways of any desirable size or shape.

Also, during operation of pump 100, the first segment 2124 (of conduit 212), the third segment 2224 (of conduit 222), and the fourth segment 2226 (of conduit 222) may each be “closed” segments. By comparison, the second segment 2126 (of conduit 212) may be an “open” segment that allows fluid to flow from the external surface 210 to the pumping chamber 208. That is, for the purposes of this application, a “closed” segment may prevent, or at least substantially prevent, direct fluid flow between the pumping chamber 208 and the external surface 210 of the casing 206 while an “open” segment may allow fluid flow between the pumping chamber 208 and the external surface 210. To be clear, “direct fluid flow” requires flow along only the segment so that, for example, fluid flowing from pumping chamber 208 to the external surface 210 along the first segment 2124 and channel 108 does not flow directly to the external surface 210 via the first segment 2124.

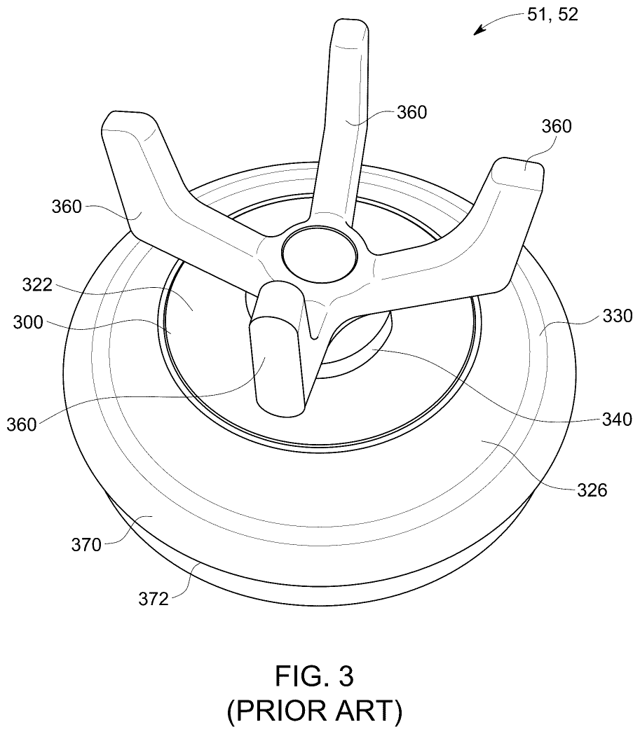

FIG. 3 illustrates a perspective view of one of the valve components 51, 52 illustrated in FIG. 2. The valve components 51, 52 may include a valve body 300, a leg assembly 340, and a sealing element or seal 370. The valve body 300 and the leg assembly 340 may be constructed from a metal, a metal alloy, or other similar material. The seal 370 may be a homogeneous elastomeric sealing element constructed from a material suitable for forming a seal, such as, but not limited to rubbers, thermoplastic materials (e.g., thermoplastic polyurethane (TPU), etc.), etc.

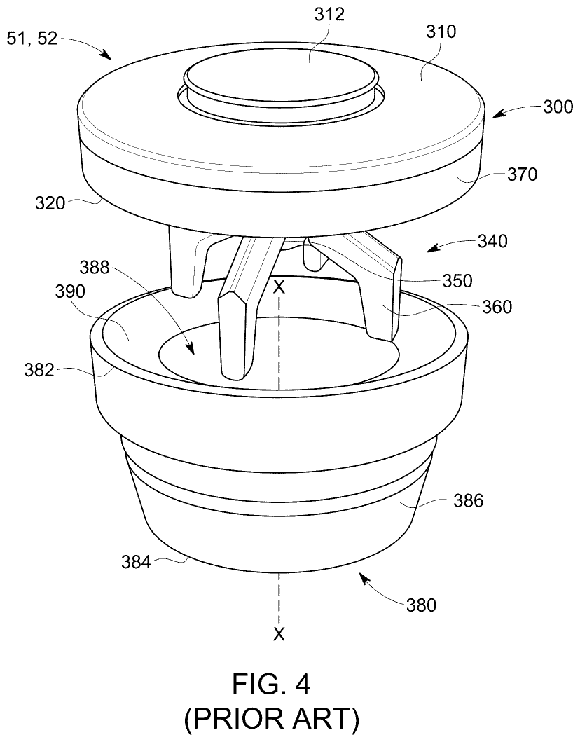

As illustrated in FIGS. 3 and 4, the valve body 300 may have a substantially circular shape and may include a first side 310 and an opposite second side 320. The first side 310 (see FIG. 4), may be substantially planar with a central cylindrical protrusion 312 (but need not include protrusion 312). The second side 320 of the valve body 300 may include a central portion 322 and a sealing portion 330. A strike surface 326 that is angled with respect to the surface of the central portion 322 of the second side 320, and with respect to the first side 310, is disposed around the perimeter of the central portion 322. As shown in FIG. 3, the sealing portion 330 may be configured to receive a sealing element or seal 370.

Meanwhile, the leg assembly 340 of the valve component 51, 52 may include a main body or base portion 350 and a set of legs 360. The set of legs 360 may be in the form of extension members that are generally L-shaped. Each leg 360 may have a first end coupled to the main body 350 of the leg assembly 340 and an opposite distal second end. As illustrated, the legs 360 may be equally spaced from one another around the main body 350 of the leg assembly 340. In different embodiments, the leg assembly 340 may be coupled to the valve body 300 or may be formed uniformly with the valve body 300. As shown in FIG. 4, the legs 360 of the leg assembly 340 are configured to extend into a central opening or conduit 388 of a valve seat 380 to guide the valve component 51, 52 into a sealing position with the valve seat 380.

Referring back to FIG. 3, the seal 370 may be coupled to the valve body 300 at the sealing portion 330 and may include a sealing surface 372 opposite an attachment surface (not shown). The attachment surface may be coupled to the sealing portion 330 of the valve body 300 by molding, adhering, or otherwise bonding the seal 370 to the sealing portion 330 of the valve body 300. The sealing surface 372 of the seal 370 may serve as an extension of the strike surface 326 of the valve body 300 when the seal 370 is coupled to the valve body 300. In other words, the seal 370 may, in conjunction with the strike surface 326 of the valve body 300, form a sealing surface of the valve component 51, 52.

Turning to FIG. 4, the prior art valve component 51, 52 is shown being inserted into a prior art valve seat 380, which is representative of that illustrated within the chamber 208 of the casing 206 in FIG. 2. The valve seat 380 may be substantially cylindrical with a first end 382, an opposite second end 384, and an outer surface 386 spanning between the first end 382 and the second end 384. The valve seat 380 includes a central conduit 388 extending through the valve seat 380 from the first end 382 to the second end 384. The first end 382 of the valve seat 380 may further include a sealing surface or strike surface 390 that extends to the conduit 388, and is oriented at an angle with respect to a central axis X of the conduit 388 such that the sealing surface 390 converges into the conduit toward the central axis X. In other words, items, components, structures, fluids, etc. that contact the sealing surface 390 may be funneled into the conduit 388 (if flowing into the valve seat 380 at first end 382) and/or may be guided radially outward (if flowing out of the valve seat 380 via the first end 382).

As illustrated in FIG. 4, as the valve component 51, 52 is moved toward the sealing surface 390 of the valve seat 380, outer surfaces of the legs 360 of the valve component 51, 52 may contact the inner surface of the conduit 388 of the valve seat 380 to position the valve component 51, 52 with respect to the valve seat 380. Consequently, the sealing surface 372 of the seal 370 and the strike surface 326 of the valve body 300 are properly aligned with the corresponding sealing surface 390 of the valve seat 380. If the valve component 51, 52 is misaligned with the valve seat 380, the legs 360 of the valve component 51, 52 may contact the sealing surface 390, which then guides the legs 360 into the conduit 388 (and aligns the valve component 51, 52 with the valve seat 380) as the valve component 51, 52 is translated toward the valve seat 380. When the legs 360 of the valve component 51, 52 are fully inserted into the conduit 388, the sealing surface 372 of the seal 370 and the strike surface 326 of the valve body 300 contact, and are in abutment with, the corresponding sealing surface 390 of the valve seat 380.

As the valve component 51, 52 is repeatedly translated away from and toward the corresponding sealing surface 390 of the valve seat 380 during operation of the pump 100, the strike surface 326 of the valve body 300 may become worn. This may be due, at least in part, to the high pressures exerted on the valve component 51, 52, particles in the operating fluid passing through the conduit 388 and over the strike surface 326, and the repeated impact of the strike surface 326 on the sealing surface 390 of the valve seat 380. Once the strike surface 326 of the valve body 300 wears to a certain degree, the valve component 51, 52 no longer functions properly (i.e., does not properly seal against the valve seat, expedites the wear of the seal 370, etc.), and the valve component 51, 52 must be replaced. This results in added maintenance costs and reduces the utilization of the pump 100 because the pump 100 must be shut down in order to install new valve components 51, 52.

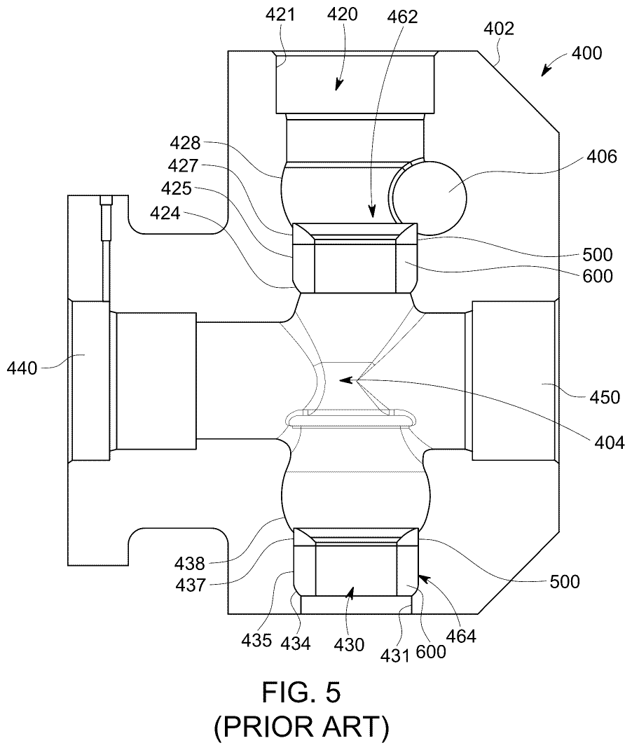

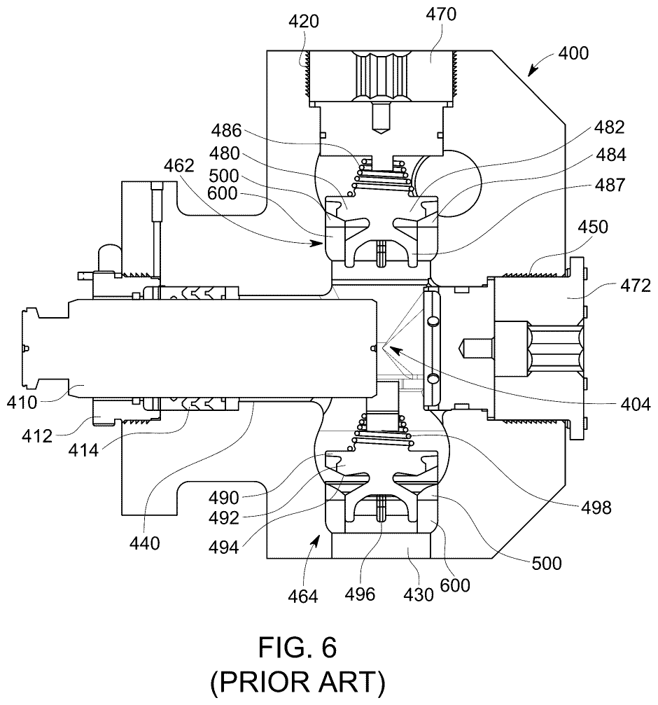

FIGS. 5 and 6 illustrate cross-sectional side view of a fluid end casing that may receive the valve seat of the present application is illustrated, but with prior versions of the valve seat assembly presented herein installed therein. These illustrations are provided simply to provide context for how the valve seats of the present application may be installed and/or utilized. In FIGS. 5 and 6, the fluid end casing 400 includes an external surface 402 and several bores in communication with a central bore 404. As shown, segments or bores 440 and 450 are generally opposite to and aligned with each other, and segments or bores 420 and 430 are generally opposite to and aligned with each other. Each of the bores 420, 430, 440, and 450 is in fluidic communication with the central bore 404. Bore 420 is also in fluidic communication with an opening 406 through which a fluid can flow out of the fluid end casing 400.

In the illustrated embodiment, bore 420 has an inner wall 421 that has different sized and shaped sections. In particular, the inner wall 421 includes a curved wall or bulbous section 428, a linear wall section 425 that engages bulbous section 428 at end or edge 427, and an angled wall section 424. Similarly, bore 430 has an inner wall 431 that has different sized and shaped sections. In particular, the inner wall 431 includes a curved wall or bulbous section 438, a linear wall section 435 that engages bulbous section 438 at end or edge 437, and an angled wall section 434.

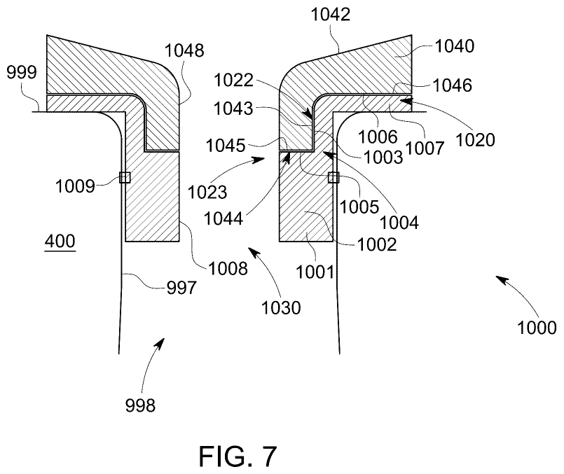

As can be seen, bore 420 includes a portion into which a valve seat assembly 462 may be inserted and press fit into place. More specifically, in FIGS. 5 and 6, a support sleeve 600 is inserted into bore 420 and moved therealong until it engages wall sections 424 and 425. The support sleeve 600 is then pressed into place in the position illustrated in FIG. 5. The strike ring 500 is then inserted into bore 420 and moved into engagement with the support sleeve 600. The strike ring 500 is press fit into the position illustrated in FIG. 5 so that its end surface proximate the support sleeve 600 engages the corresponding and proximate end surface of the support sleeve 600. Similarly, a support sleeve 600 and a strike ring 500 are inserted into bore 430 (perhaps via bore 450) and press fit into the positions illustrated in FIG. 5. However, to reiterate, the support sleeves 600 and strike rings 500 shown in FIGS. 5 and 6 may be representative of similar support sleeves and strike rings shown and described in connection with FIGS. 7-14. That is, the support sleeves and strike rings shown in FIGS. 5 and 6 may be representative of positions in which support sleeves and strike rings described in connection with FIGS. 7-14 may be utilized.

In FIG. 6, the fluid end casing 400 of FIG. 5 is illustrated with additional components. In this embodiment, closure elements 470 and 472 are mounted in bores 420 and 450, respectively, and retained therein via threads on the inner walls defining the bores 420 and 450, respectively. The fluid end casing 400 includes a reciprocating member 410, such as a piston or plunger, mounted in bore 440 for movement relative to the fluid end casing 400. A retaining element 412 is threadedly coupled to the fluid end casing 400 and retains the packing assembly 414 in place relative to the fluid end casing 400.

For bore 420, a valve or valve component 480 is shown relative to the valve seat assembly of strike ring 500 and support sleeve 600. The valve 480 is engaged by a biasing member 486, such as a spring, that applies a force to the valve 480 into a closed position in which the valve 480 engages the valve seat assembly 462. In FIG. 6, the valve 480 is illustrated in its closed position, in which the valve 480 prevents any fluid from flowing through valve seat assembly 462 and into the central bore 404. Similarly, for bore 430, another valve or valve component 490 is shown relative to the valve seat assembly 464, which includes a strike ring 500 and a support sleeve 600. A biasing member 498, such as a spring, engages the valve 490 and applies a force to bias the valve 490 into its closed position. In FIG. 6, the valve 490 is illustrated in its open position, in which the valve 490 is spaced apart from and does not engage the valve seat assembly 464. Additionally, biasing member 498 is compressed, e.g., because fluid is flowing through valve seat assembly 464 and into the central bore 404. In the illustrated embodiment, valves 480, 490 are similar to valves 51, 52 of FIGS. 2 and 3. Thus, valve 480 include a body 482 that has a sealing or strike surface 484 that engages a strike surface on the strike ring 500. Coupled to the body 482 is a leg assembly 487 that includes several legs as shown. Similarly, valve 490 includes a body 492 that has a sealing or strike surface 494 that engages a strike surface on the strike ring 500. Valve 490 also includes a leg assembly 496 coupled to body 492, with the leg assembly 496 having several legs.

FIGS. 7-14 depict valve seat assemblies 1000, 1100, 1200, 1300, 1400, 1500, 1600, 1700, of portions thereof, of the present application. These valve seat assemblies 1000, 1100, 1200, 1300, 1400, 1500, 1600, 1700 are somewhat similar to the valve seat assemblies 462, 464 of FIGS. 5 and 6 but include different features that have been found to provide advantageous, long-lasting valve seats. That is, valve seat assemblies 1000, 1100, 1200, 1300, 1400, 1500, 1600, 1700 provide benefits that are not otherwise achieved by prior art valve seat assemblies 462, 464. More specifically, valve seat assemblies 1000, 1100, 1200, 1300, 1400, 1500, 1600, 1700, which may also be referred to as a valve seat or variations thereof, each include a strike ring 1040, 1140, 1240, 1340, 1440, 1540, 1640, 1740 (also referred to as strike portion, first portion, strike member, first member, and the like) that is similar to strike ring 500 and a support sleeve or member 1002, 1102, 1202, 1302, 1402, 1502, 1602, 1702 (also referred to as support portion, second portion, and the like) that is similar to support sleeve 600, but the strike rings and the support sleeves of each assembly are coupled together via mating features and/or joints. The mating features may be surfaces that are configured to receive and support an adhesive or allow another chemical coupling, surfaces that allow brazing or other similar techniques, and/or surfaces that mechanically engage with each other (with or without thermal assistance).

Moreover, in FIGS. 7-14, the support sleeves 1002, 1102, 1202, 1302, 1402, 1502, 1602, 1702 contact the fluid end casing 400 and the strike rings 1040, 1140, 1240, 1340, 1440, 1540, 1640, 1740 contact their respective support sleeve 1002, 1102, 1202, 1302, 1402, 1502, 1602, 1702 without contacting the fluid end casing 400 (e.g., surfaces defining the bore in which the valve seat assembly is sitting). Thus, the support sleeves 1002, 1102, 1202, 1302, 1402, 1502, 1602, 1702 are each an intermediary component between the fluid end casing 400 and their respective strike ring 1040, 1140, 1240, 1340, 1440, 1540, 1640, 1740. This is largely because the support sleeves 1002, 1102, 1202, 1302, 1402, 1502, 1602, 1702 may be formed from a first material with a first hardness and the strike ring 1040, 1140, 1240, 1340, 1440, 1540, 1640, 1740 may be constructed from a second material that has a second hardness that is harder than the hardness of the strike ring 1040, 1140, 1240, 1340, 1440, 1540, 1640, 1740. Thus, when one of support sleeves 1002, 1102, 1202, 1302, 1402, 1502, 1602, 1702 acts as an intermediary component, it may protect the fluid end casing 400 from the enhanced wear or abrasion that the fluid end casing 400 might experience from direct contact with the harder strike ring 1040, 1140, 1240, 1340, 1440, 1540, 1640, 1740. That is, the relatively softer material of the support sleeve 1002, 1102, 1202, 1302, 1402, 1502, 1602, 1702 may act as the wear interface for the relatively harder material of the strike ring 1040, 1140, 1240, 1340, 1440, 1540, 1640, 1740 and for the fluid end casing 400.

As an example, each of support sleeves 1002, 1102, 1202, 1302, 1402, 1502, 1602, 1702 may be constructed from a first steel formulation and each strike ring 1040, 1140, 1240, 1340, 1440, 1540, 1640, 1740 may be formed from a different, harder steel formulation. Alternatively, in at least one embodiment, a strike ring 1040, 1140, 1240, 1340, 1440, 1540, 1640, 1740 is constructed from a carbide material (e.g., tungsten carbide) and a corresponding support sleeve 1002, 1102, 1202, 1302, 1402, 1502, 1602, 1702 is constructed from steel that is not as hard as the carbide. While the structure of a carbide material may be weak in tension, it may have a relatively high strength under compression, which is important for the construction presented in the present application. For example, the compressive strength of these materials may be higher than virtually all melted and cast or forged metals and alloys. In addition, these materials may be two to three times more rigid than steel and four to six times more rigid than cast iron and brass.

Across the various embodiments of FIGS. 7-14, the strike ring and the support sleeve each have an annular shape (e.g., a circular ring-shaped configuration). Additionally, the support sleeves and strike rings each generally extend from an upper or first end or surface to a lower or second end or surface and from an outer end or surface to an inner end or surface. In at least some embodiments, the outer surfaces of the support sleeves and/or the strike rings can match inner bore surfaces of bores in a fluid end casing. This may allow these components to fit tightly and securely into a fluid end bore. For example, in some instances, each of the support sleeves may be press fit into a fluid end to interlock with the fluid end. Meanwhile, the top end surface of each strike ring may generally define a strike surface that is engaged by a corresponding strike surface on a valve component while the bottom end surface of the strike ring engages with the support sleeve (the manner of this engagement is detailed below). In at least some embodiments, the strike surface of the strike ring may be tapered, e.g., at an angle of approximately 30 degrees relative to an axis extending through the center of the bore defined by a valve assembly and/or relative to an inner surface of the valve assembly (defined by the strike ring and/or the support sleeve). This strike surface may also have a width designed so that it can be engaged by both the strike surface and the sealing element of a valve component.

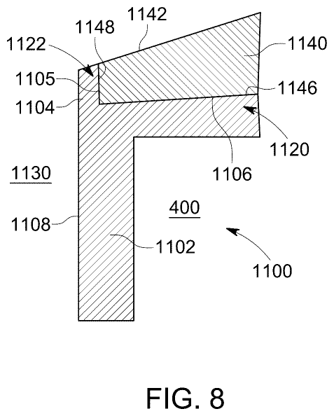

Now turning specifically to FIGS. 7 and 8, these figures depict embodiments with strike ring and support sleeve geometries that create two mating surfaces extending in different directions. This, in turn, enhances the coupling between the strike ring and the support sleeve, e.g., as compared to configurations with only a single mating surface and/or with mating surfaces that generally extend in the same direction.

In FIG. 7, the valve seat assembly 1000 includes a support sleeve 1002 with a first portion 1001 and a second portion 1007. The first portion 1001 and the second portion 1007 generally extend in transverse directions. For example, the first portion 1001 may be configured to insert into a bore 998 (e.g., the bore 420, the bore 430) defined by the fluid end casing 400, whereas the second portion 1007 may be configured to engage a shoulder 999 formed by the fluid end casing 400.

The first portion 1001 is configured to engage a wall section 997 (e.g., the linear wall section 425, the linear wall section 435) of the fluid end casing 400 to secure the support sleeve 1002 to the fluid end casing 400. In some embodiments, the valve seat assembly 1000 includes a seal 1009 (e.g., an O-ring) surrounding the first portion 1001 and configured to be compressed between the first portion 1001 and the wall section 997, which may relative block movement between the first portion 1001 and the wall section 997, further securing the support sleeve 1002 to the fluid end casing 400. The seal 1009 may also block fluid, debris, and other particles from flowing between the first portion 1001 and the wall section 997, which may reduce wear of the support sleeve 1002.

The support sleeve 1002 is configured to couple to a strike ring 1040. To this end, the support sleeve 1002 includes a mating feature in the form of a radially interior groove 1004 formed into a top end surface 1006. The interior groove 1004 and the top end surface 1006 are configured to engage with an inner axial protrusion 1044 (a corresponding mating feature) of the strike ring 1040 and a bottom end surface 1046 of the strike ring 1040, respectively, to provide an interface formed by a female mating feature (e.g., the interior groove 1004) of the support sleeve 1002 and a male mating feature (e.g., the inner axial protrusion 1044) of the strike ring 1040. Thus, the strike ring 1040 can engage with the support sleeve 1002 along at least two joints or mating features extending in different directions: a radially extending joint 1020 (formed by top end surface 1006 and bottom end surface 1046) and an axially extending joint 1022 (formed between the interior groove 1004 and the inner axial protrusion 1044). More specifically, an exterior axial surface 1043 of the strike ring 1040 can engage with the support sleeve 1002 along the axially extending joint 1022 to form a first engagement that extends generally parallel to a central axis of a bore 1030 of the valve seat assembly 1000 through which fluid may flow, and the bottom end surface 1046 extends transverse to the exterior axial surface 1043 and can also engage with the support sleeve 1002 along the radially extending joint 1020 to form a second engagement that is substantially normal or transverse to the first engagement (e.g., generally perpendicular to the central axis of bore 1030).

The axially extending joint 1022 can secure the strike ring 1040 and the support sleeve 1002 together in a manner that, at a minimum, ensures the two components are radially aligned and do not become radially offset with respect to each other (e.g., do not lose concentricity). Meanwhile, the radially extending joint 1020 can ensure that the strike ring 1040 sits flat atop of the support sleeve 1002. In some instances, the radially extending joint 1020 can also act to prevent axially separation between the strike ring 1040 and the support sleeve 1002, e.g., if the strike ring 1040 is sufficiently press fit onto the support sleeve 1002 and/or if an adhesive, chemical bond, etc. is applied along the radially extending joint 1020. Moreover, in the depicted embodiment, the inner axial protrusion 1044 and the radially interior groove 1004 also form a second radial joint 1023 (in addition to the axially extending joint 1022). This is because the inner axial protrusion 1044 includes the exterior axial surface 1043 and a bottom surface 1045 that face and mate with an exterior axial surface 1003 of the interior groove 1004 and a bottom surface 1005 of the interior groove 1004, respectively. That is, the bottom surface 1005 of the support sleeve 1002 extends radially inward from the exterior axial surface 1003 of the support sleeve 1002 to provide a lip to which the bottom surface 1045 of the strike ring 1040 may abut.

In different embodiments, one or more of joints 1020, 1022, and 1023 may be secured via adhesives and/or bonding techniques now known or developed hereafter. For example, mating surfaces that abut at one or more of joints 1020, 1022, and 1023 may be bonded via thermal bonding techniques, diffusion bonding techniques, solvent bonding techniques, etc. Additionally or alternatively, abutting joint surfaces may be bonded via brazing, welding, and/or via press fit connections. Bonded mating surfaces may further secure the strike ring 1040 in place with respect to the support sleeve 1002 and discourage these components from separating and/or acting independently. Among other advantages, this may prevent fluid and debris from moving between the strike ring 1040 and the support sleeve 1002, which may prevent abutting mating surfaces from experiencing unwanted wear.

In the embodiment of FIG. 7, an inner surface 1008 of the support sleeve 1002 acts in combination with an inner surface 1048 of the strike ring 1040 to define the bore 1030 through the valve seat assembly 1000. However, as mentioned above, the strike ring 1040 does not contact a substantial portion of the fluid end casing 400 and, instead, sits entirely stop of the support sleeve 1002. In other words, the support sleeve 1002 limits contact between the strike ring 1040 and the fluid end casing 400 (e.g., the wall section 997, the shoulder 999), such as by blocking the bottom end surface 1046 extending radially along the radially extending joint 1020 from contacting the fluid end casing 400. At the same time, the strike ring 1040 is sized and shaped to define a strike surface 1042 that is engaged by a corresponding strike surface on a valve component. Because the strike ring 1040 covers the top end surface 1006 of the support sleeve 1002, the strike ring 1040 blocks exposure of the top end surface 1006 to the strike surface of the valve component. Therefore, the strike ring 1040 blocks the top end surface 1006 from contacting the valve component, thereby preventing or at least discouraging wear of the support sleeve 1002 otherwise caused by force imparted by the valve component. Thus, the hard material of the strike ring 1040 is adequately secured in place atop of the support sleeve 1002 (via radially extending joint 1020 and axially extending joint 1022), receives wear from repeated interactions with the valve (via its strike surface), and does not directly transfer this wear to the fluid end casing 400 (due to the support sleeve 1002 interposed therebetween).

FIG. 8 depicts a valve seat assembly 1100 that is substantially similar to valve seat assembly 1000 and including a support sleeve 1102 and a strike ring 1140 configured to engage with one another; however, now, support sleeve 1102 includes a mating feature in the form of an extension 1104 instead of a groove formed into a top end surface 1106. The extension 1104 extends transverse to the top end surface 1106 of the support sleeve 1102, such as along an inner surface 1108 of the support sleeve 1102, and the strike ring 1140 is configured to receive and engage with the extension 1104 to abut a bottom end surface 1146 of the strike ring 1140 against the top end surface 1106 of the support sleeve 1102. Consequently, valve seat assembly 1100 includes a configuration in which an axially extending joint 1122 is formed by a male mating feature (e.g., the extension 1104) of the support sleeve 1102 and a female mating feature (e.g., an opening formed into a bottom end surface 1146) of the strike ring 1140 (as opposed to the opposite for valve seat assembly 1000). More specifically, with extension 1104, a radially exterior surface 1105 of extension 1104 abuts an inner surface 1148 of the strike ring 1140 to form an axially extending joint 1122. Meanwhile, the top end surface 1106 of the support sleeve 1102 engages the bottom end surface 1146 of the strike ring 1140 to form a radially extending joint 1120. Thus, valve seat assembly 1100 realizes the advantages of having at least two joints extending in two different directions (discussed above in connection with valve seat assembly 1100). In still further embodiments, these advantages could also be achieved with other variations of valve seat assembly 1000 and valve seat assembly 1100, such as with one or more extensions extending from a middle or exterior portion of the top end surface 1106 of the support sleeve 1102 and/or the bottom end surface 1146 of strike ring 1140.

The valve seat assembly 1100 also differs from valve seat assembly 1000 because the inner surface 1108 of the support sleeve 1102 defines the entire bore 1130 through the valve seat assembly 1100 through which fluid may flow. Minimizing the amount of the central bore 1130 formed by the strike ring 1140 may minimize wear that is imparted to the strike ring 1140 by fluid and debris. That is, the strike ring 1140 terminates prior to the bore 1130, and the extension 1104 may block fluid and/or debris from contacting the strike ring 1140 (e.g., the inner surface 1148) and, thus, may preserve the strike ring 1140 to act as a strike surface for a valve. Forming the bore 1130 with only one component may also eliminate a risk of contaminants moving between the two components. However, to be clear, this is merely one example arrangement and, in other embodiments, the axially extending joint 1122 might be formed in a manner that causes the strike ring 1140 to form a portion of the bore 1130, provided that the strike ring 1140 (e.g., the radially extending bottom end surface 1146) does not contact a substantial amount of the fluid end casing 400 and, instead, sits entirely stop of the support sleeve 1102.

In fact, the support sleeve 1102 including the extension 1104 may define a portion of a top end portion 1142 of the valve seat assembly 1100. This portion defined by the extension 1104 is relatively small so that the strike ring 1140 still forms a majority of the top end portion 1142. Indeed, the strike ring 1140 covers the top end surface 1106 of the support sleeve 1102 to block exposure of the top end surface 1106 to a valve (e.g., a strike surface of the valve), thereby blocking contact between the valve and the top end surface 1106. Moreover, with the arrangement depicted in FIG. 8, the extension 1104 is on an interior edge and, thus, might not engage a corresponding strike surface on a valve component with the strike ring 1140. That is, the strike ring 1140 may be configured to engage the corresponding strike surface on the valve component without the support sleeve 1102. However, in other embodiments, the extension 1104 might be in a different radial location and, may for example, extend into or split the strike ring 1140 (e.g., bisecting the strike ring 1140), as long as the strike ring 1140 still forms a large majority of the strike surface of the valve seat assembly 1100 configured to engage a corresponding strike surface on a valve component (e.g., over 60% of the strike surface, over 75% of the strike surface, over 85% of the strike surface, or over 90% or more of the strike surface). In any case, joints 1120 and 1122 ensure that the hard material of the strike ring 1140 is adequately secured in place atop of the support sleeve 1102, receives wear from repeated interactions with the valve (via its strike surface), and does not directly transfer this wear to the fluid end casing 400 (due to the support sleeve 1102 interposed therebetween).

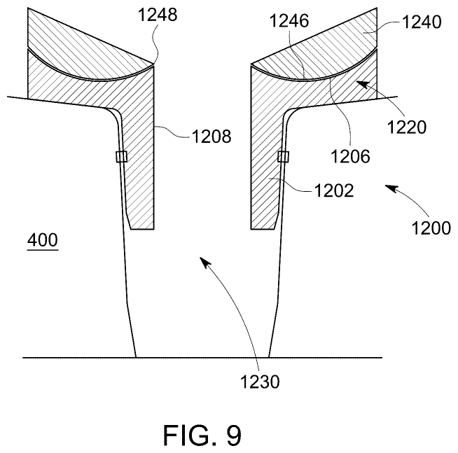

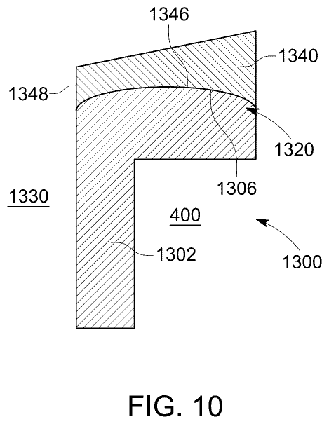

Now turning specifically to FIGS. 9 and 10, these figures depict embodiments with strike ring and support sleeve geometries that create an arcuate mating feature. This arcuate mating feature enhances the coupling between the strike ring and the support sleeve, e.g., as compared to configurations with only a single, planar mating surface and/or with mating surfaces that generally extend in the same direction. Additionally, for each embodiment, the strike ring covers the mating surface of the support sleeve to block exposure of the mating surface of the support sleeve to a valve, thereby blocking contact between the mating surface of the support sleeve and the valve.

In FIG. 9, the valve seat assembly 1200 includes a support sleeve 1202 with a mating feature in the form of a concave top end surface 1206 that is configured to engage with a mating feature in the form of a convex bottom end surface 1246 of a strike ring 1240, thereby blocking the radially extending convex bottom end surface 1246 from contacting the fluid end casing 400. Thus, the strike ring 1240 can engage with the support sleeve 1202 along a non-planar (e.g., arcuate) joint 1220 (formed by concave top end surface 1206 and bottom end surface 1046). Critically, since the non-planar joint 1220 is not flat, it secures the strike ring 1240 and support sleeve 1202 together with respect to multiple degrees of freedom. That is, the non-planar joint 1220 can secure the strike ring 1240 and the support sleeve 1202 together in a manner that, at a minimum, ensures the two components are radially aligned and do not become radially offset with respect to each other, such as by blocking relative translational movement of the strike ring 1240 and the support sleeve 1202 alongside one another. Additionally or alternatively, the non-planar joint 1220 can ensure that the strike ring 1240 sits flat atop of the support sleeve 1202 and/or can prevent axially separation between the strike ring 1240 and the support sleeve 1202, e.g., if the strike ring 1040 is sufficiently press fit onto the support sleeve 1002 and/or if an adhesive, chemical, etc. is applied along the radially extending joint 1020. Indeed, in different embodiments, non-planar joint 1220 may be secured via adhesives and/or bonding techniques now known or developed hereafter, e.g., as discussed above in connection with FIGS. 7 and 8.

With the arrangement of arcuate surfaces depicted in FIG. 9, a central bore 1230 of the valve seat assembly 1200 through which fluid may flow may be entirely defined by an inner surface 1208 of the support sleeve 1202 or the central bore 1230 may be defined by a combination of the inner surface 1208 of the support sleeve 1202 and an inner surface 1248 of the strike ring 1240. Minimizing the amount of the central bore 1230 formed by the strike ring 1240 may minimize wear that is imparted to the strike ring 1240 by fluid and debris and, thus, may preserve the strike ring 1240 to act as a strike surface for a valve.

FIG. 10 depicts a valve seat assembly 1300 that is substantially similar to valve seat assembly 1200; however, now, support sleeve 1302 includes a mating feature in the form of a convex top end surface 1306 instead of a concave top end surface. Correspondingly, a strike ring 1340 of the valve seat assemblies 1300 includes a mating feature in the form of a bottom end surface 1346 that is concave and configured to mate with the convex top end surface 1306 of the support sleeves 1302 to form a non-planar joint 1320. With this rearrangement, a larger portion of an inner surface 1348 of the strike ring 1340 may form a portion of the bore 1330 (or a larger portion of the bore 1330) that extends through the valve seat assembly 1300 and that may receive fluid flow. However, to be clear, this is merely one example arrangement and, in other embodiments, the bottom end surface 1346 might be formed in a manner that causes the strike ring 1340 to form more or less of the bore 1330, provided that the strike ring 1340 (e.g., the radially extending convex bottom end surface 1346) does not contact a substantial portion of the fluid end casing 400 and, instead, sits entirely stop of the support sleeve 1302.

Indeed, in other embodiments, the convex top end surface 1306 of the support sleeve 1302 and the bottom end surface 1346 of the strike ring 1340 need not be concave or convex in the manners depicted and may have any desirable shapes or configurations while still realizing the advantages of a non-planar joint between the strike ring 1240 and the support sleeve 1202. That said, in any case, the non-planar joint 1320 ensures that the hard material of the strike ring 1340 is adequately secured in place atop of the support sleeve 1302, receives wear from repeated interactions with the valve (via its strike surface), and does not directly transfer this wear to the fluid end casing 400 (due to the support sleeve 1302 interposed therebetween).

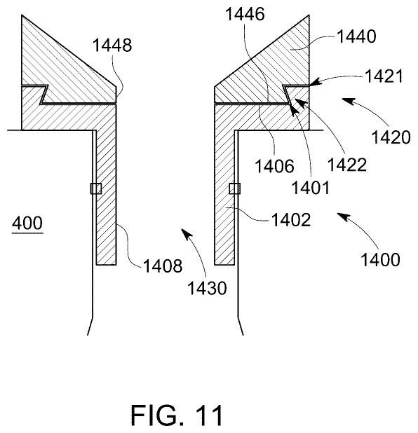

FIGS. 11-14 depict embodiments with strike ring and support sleeve geometries that create a wedge mating feature between the strike ring and the support sleeve. This wedge, which may also be referred to as a thermal wedge, enhances the coupling between the strike ring and the support sleeve, e.g., as compared to configurations with only a single, planar mating surface and/or with mating surfaces that generally extend in the same direction. Moreover, in some instances, the thermal wedge may mechanically secure the strike ring to the support sleeve without requiring further bonding techniques therebetween. That is, the wedge may eliminate the need for adhesives, chemicals, brazing, or other such bonding techniques. The various embodiments include different configurations (e.g., locations) of wedge mating features, but for each embodiment, the strike ring covers a surface on which the wedge mating feature of the support sleeve is formed, thereby blocking exposure of the surface to a valve.

In FIG. 11, the valve seat assembly 1400 includes a support sleeve 1402 with a male wedge mating feature 1422 extending from a radially exterior portion 1401 of its top end surface 1406. Meanwhile, the support sleeve 1402 includes a corresponding female wedge mating feature 1421 formed in its bottom end surface 1446. When the strike ring 1440 engages with the support sleeve 1402, the male wedge mating feature 1422 engages the corresponding female wedge mating feature 1421 to form a wedge joint 1420. Again, since the wedge joint 1420 is not flat or planar, the wedge joint 1420 secures the strike ring 1440 and support sleeve 1402 together (e.g., blocks relative movement between the strike ring 1440 and the support sleeve 1402) with respect to multiple degrees of freedom. That is, the wedge joint 1420 can secure the strike ring 1440 and the support sleeve 1402 together in a manner that, at a minimum, ensures the two components are radially aligned and do not become radially offset with respect to each other (e.g., do not lose concentricity). Additionally or alternatively, the wedge joint 1420 can ensure that the strike ring 1440 sits flat atop of the support sleeve 1402 and/or the wedge joint can prevent axially separation between the strike ring 1440 and the support sleeve 1402, such as via an interlocking snap-type interface fastening the strike ring 1440 and the support sleeve 1402 to one another.

In at least some instances, the wedge joint 1420 can fully couple the support sleeve 1402 to the strike ring 1440 without any adhesives or bonding techniques; the wedge joint 1420 can mechanically retain the two components in place with respect to each other (e.g., via the interlocking snap-type interface). That said, in some instances, the wedge joint 1420 may need to be assembled at high temperatures to achieve the desired mechanical retention (e.g., to create a thermal wedge).

With the arrangement of surfaces depicted in FIG. 11, a central bore 1430 of the valve seat assembly 1400 through which fluid may flow may be defined by both an inner surface 1408 of the support sleeve 1402 and an inner surface 1448 of the strike ring 1440. However, the radially exterior portion 1401 of the wedge joint 1420 and/or the male/female arrangement of FIG. 9 may allow minimization of the amount of the central bore 1430 formed by the strike ring 1440 (e.g., by reducing an amount of surface area needed at the inner surface 1448). In turn, this may minimize wear that is imparted to the strike ring 1440 by fluid and debris and, thus, may preserve the strike ring 1440 to act as a strike surface for a valve. That said, in any case, the wedge joint 1420 ensures that the hard material of the strike ring 1440 is adequately secured in place atop of the support sleeve 1402, receives wear from repeated interactions with the valve (via its strike surface), and does not directly transfer this wear to the fluid end casing 400 (due to the support sleeve 1402 interposed therebetween to block contact between the radially extending bottom end surface 1446 with the fluid end casing 400).

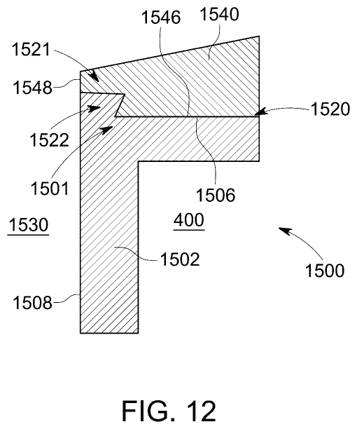

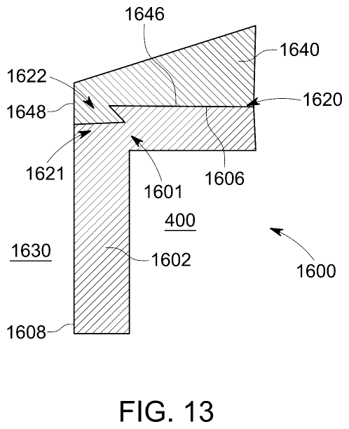

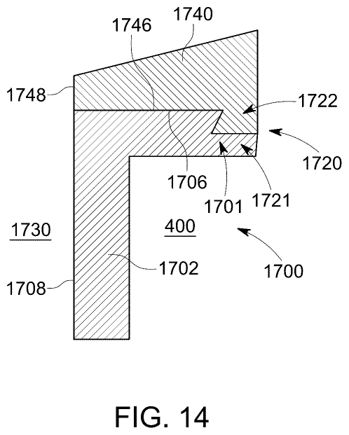

FIGS. 12-14 depict valve seat assemblies 1500, 1600, 1700, respectively, that are substantially similar to valve seat assembly 1400; however, the thermal wedge is moved and/or reconfigured to demonstrate some possible alternative arrangements of valve seat assembly 1400. In FIG. 12, valve seat assembly 1500 provides a thermal wedge joint 1520 in a radially interior location 1501 (i.e., toward a bore 1530 defined by the valve seat assembly 1400 and through which fluid may flow), but a male wedge mating feature 1522 still extends from a top end surface 1506 of the support sleeve 1502 and a female wedge mating feature 1521 is still disposed on a bottom end surface 1546 of the strike ring 1540. In FIG. 13, the valve seat assembly 1600 again provides a thermal wedge joint 1620 in a radially interior location 1601 (i.e., toward a bore 1630 defined by the valve seat assembly 1600 and through which fluid may flow), but a male wedge mating feature 1622 now extends from a bottom end surface 1646 of strike ring 1640 while a female wedge mating feature 1621 is disposed on a top end surface 1606 of the support sleeve 1602. Finally, in FIG. 14, the valve seat assembly 1700 provides a thermal wedge joint 1720 in a radially exterior location 1701 (e.g., away from a bore 1730 defined by the valve seat assembly 1700 and through which fluid may flow), but with a male wedge mating feature 1722 extending from a bottom end surface 1746 of the strike ring 1740 and a female wedge mating feature 1721 formed in a top surface 1706 of the support sleeve 1702.

Across these embodiments, inner surfaces 1548, 1648, and 1748 of strike rings 1540, 1640, and 1740 cooperate with inner surfaces 1508, 1608, and 1708, and support sleeves 1502, 1602, and 1702, to define the bores 1530, 1630, and 1730 through the valve seat assemblies 1500, 1600, 1700. However, as mentioned above, providing the wedge joint 1520, 1620, 1720 in a radially exterior location and/or including the male portion of the wedge joint 1520, 1620, 1720 on the support sleeve may allow minimization of the amount of the central bore 1530, 1630, and 1730 formed by the strike ring 1540, 1640, 1740. In turn, this may minimize wear that is imparted to the strike ring 1540, 1640, 1740 by fluid and debris and, thus, may preserve the strike ring 1540, 1640, 1740 to act as a strike surface for a valve. That said, in any case, the wedge joints 1520, 1620, 1720 ensure that the hard material of each strike ring 1540, 1640, 1740 is adequately secured in place atop of its support sleeve 1502, 1602, 1702, receives wear from repeated interactions with the valve (via its strike surface), and does not directly transfer this wear to the fluid end casing 400 (due to the support sleeve 1502, 1602, 1702 interposed therebetween to block, for example, contact between the radially extending bottom end surfaces 1546, 1646, 1746 with the fluid end casing 400).

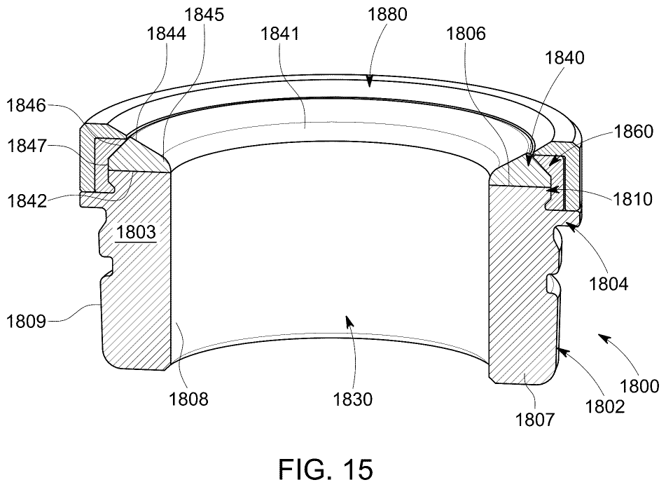

FIGS. 15-17 depict valve seat assemblies 1800 and 1801, or portions thereof, of the present application. Valve seat assemblies 1801 and 1801 are somewhat similar to the valve seat assemblies 462, 464 of FIGS. 5 and 6 (e.g., in overall geometry) but include different features that have been found to provide advantageous, long-lasting valve seats. That is, valve seat assemblies 1800 and 1801 provide benefits that are not otherwise achieved by prior art valve seat assemblies 462, 464. More specifically, valve seat assemblies 1800 and 1801, which may also be referred to as a valve seat or variations thereof, each include a strike ring 1840 (also referred to as strike portion, first portion, strike member, first member, and the like) that is similar to strike ring 500 and a support sleeve or member 1802 (also referred to as support portion, second portion, and the like) that is similar to support sleeve 600, but the strike rings 1840 and the support sleeves 1802 of each assembly are coupled together via one or more additional rings. More specifically, valve seat assembly 1800 and valve seat assembly 1801 each include one or more additional rings that secure a strike ring 1840 to a support sleeve 1802 to mate these two components together without requiring any additional bonding techniques, such as those that utilize adhesives, chemicals, brazing, welding, etc. That said, in some embodiments, various rings/components might be bonded together if desired.

Overall, the valve seat assembly 1800 and the valve seat assembly 1801 may include the same support sleeve 1802 and the same strike ring 1840. In the depicted embodiment, the support sleeve 1802 includes an annular, circular main body 1803 that extends from an inner surface 1808 to an outer surface 1809 and from a top end surface 1806 to a bottom end surface 1807. The inner surface 1808 defines at least a portion of a central bore 1830 that extends through the valve seat assembly 1800 or the valve seat assembly 1801. Meanwhile, the outer surface 1809 includes features that help seat the support sleeve 1802 in a fluid end bore (e.g., the bore 420, the bore 430 defined by the fluid end casing 400). In fact, in at least some embodiments, the outer surface 1809 can match inner bore surfaces of bores in a fluid end casing to allow these components to fit tightly and securely into a fluid end bore, while slots or grooves in the outer surface 1809 support a seal that seals against this fluid end bore. For example, in some instances, each of the support sleeve may be press fit into a fluid end to interlock with the fluid end and seal thereagainst. Additionally, in the depicted embodiment, a flange 1804 extends radially outwards from the outer surface 1809. The flange 1804 may sit above or below a fluid end bore (e.g., against a shoulder) in which the valve seat assembly is installed, and the flange 1804 may support the additional rings of valve seat assemblies 1800, 1801 that act to couple the strike ring 1840 to the support sleeve 1802, as is described in further detail below.

The strike ring 1840 generally sits atop the top end surface 1806 of support sleeve 1802 and is configured to define at least a portion of a strike surface that is engaged by a corresponding strike surface on a valve component. In at least some embodiments, the strike surface of the strike ring may be tapered, e.g., at an angle of approximately 30 degrees relative to an axis extending through the center of the bore defined by the valve seat assembly and/or relative to an inner surface of the valve seat assembly. This strike surface may also have a width designed so that it can be engaged by both the strike surface and the sealing element of a valve component.

In the depicted embodiment, the strike ring 1840 includes an annular, circular main body 1841 that extends from an inner surface 1845 to an outer surface 1847. At one axial end of the main body 1841, a top inner surface 1844 and a top outer surface 1846 extend between the inner surface 1845 and the outer surface 1847. The top inner surface 1844 is tapered and is generally configured to define at least a portion of the aforementioned strike surface. Meanwhile, the top outer surface 1846 and/or the outer surface 1847 are configured to engage with additional rings of valve seat assembly 1800 or valve seat assembly 1801 to secure the strike ring 1840 to the support sleeve 1802. Still further, at an opposite axial end of the strike ring 1840, a bottom surface 1842 may be a relatively planar surface that extends between the inner surface 1845 and the outer surface 1847. The bottom surface 1842 of the strike ring 1840 is generally configured to engage with the support sleeve 1802 by sitting atop the top end surface 1806 of the support sleeve 1802. Consequently, the bottom surface 1842 covers the top end surface 1806 to block exposure of the top end surface 1806 to a valve component while also avoiding contact with a fluid end casing to block contact between the strike ring 1840 and a fluid end casing.

With valve seat assembly 1800 and valve seat assembly 1801, the support sleeve 1802 is configured to contact a fluid end casing (see, e.g., fluid end casing 400 of FIG. 5) and the strike ring 1840 contacts the support sleeve 1802 without contacting a substantial portion of the fluid end casing (e.g., surfaces defining the bore in which the valve seat assembly is sitting). Thus, the support sleeve 1802 acts an intermediary component between the fluid end casing 400 and the strike ring 1840. This is largely because the support sleeve 1802 may be formed from a first material with a first hardness and the strike ring 1840 may be constructed from a second material that has a second hardness that is harder than the hardness of the strike ring 1840. When the support sleeve 1802 acts as an intermediary component, it may protect the fluid end casing from the enhanced wear or abrasion that the fluid end casing might experience from direct contact with the harder strike ring 1840. That is, the relatively softer material of the support sleeve 1802 may act as the wear interface for the relatively harder material of the strike ring 1840 and for the fluid end casing 400.

As an example, support sleeve 1802 may be constructed from a first steel formulation and strike ring 1840 may be formed from a different, harder steel formulation. Alternatively, in at least one embodiment, strike ring 1840 is constructed from a carbide material (e.g., tungsten carbide) and support sleeve 1802 is constructed from steel that is not as hard as the carbide. While the structure of a carbide material may be weak in tension, it may have a relatively high strength under compression, which is important for the construction presented in the present application. For example, the compressive strength of these materials may be higher than virtually all melted and cast or forged metals and alloys. In addition, these materials may be two to three times more rigid than steel and four to six times more rigid than cast iron and brass.

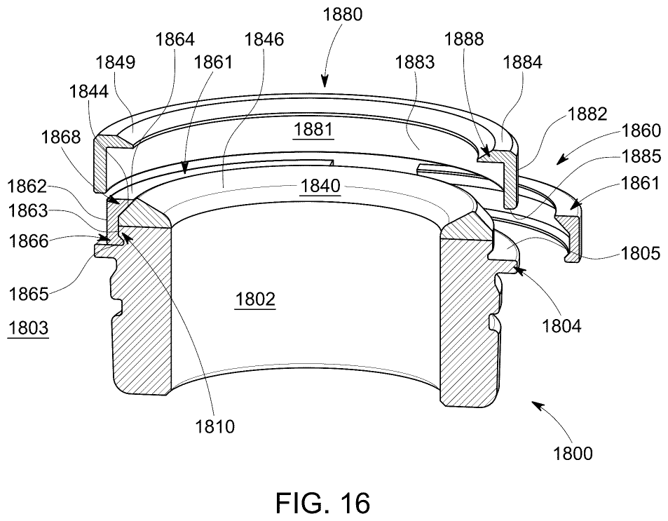

Now turning specifically to FIGS. 15 and 16, in valve seat assembly 1800, the strike ring 1840 is secured to the support sleeve 1802 with two additional components: a coupling ring 1860 and a cover ring 1880. At a high-level, the coupling ring 1860 wraps around portions of both the strike ring 1840 (e.g., the outer surface 1847, the top outer surface 1846) and the support sleeve 1802 while the cover ring 1880 secures the coupling ring 1860 in place to clamp the strike ring 1840 to the support sleeve 1802. To effectuate this, the coupling ring 1860 is provided in multiple pieces 1861 (or bodies) that need not be coupled together. Instead, the cover ring 1880 serves to secure the multiple pieces 1861 of the coupling ring 1860 in place around a circumference of the strike ring 1840 and around a circumference of the support sleeve 1802. Positioning the cover ring 1880 radially exteriorly of the coupling ring 1860 fills the space between the coupling ring 1860 and a fluid end bore such that the fluid end casing compresses the cover ring 1880 against the coupling ring 1860, thereby forcing the coupling ring 1860 into tight engagement with the support sleeve 1802 and strike ring 1840. Thus, the coupling ring 1860 and the cover ring 1880 can mate the support sleeve 1802 with the strike ring 1840 without requiring any additional bonding techniques, such as those that utilize adhesives, chemicals, brazing, welding, etc. (unless such bonding is desired).

As some more detail, the coupling ring 1860 includes multiple pieces 1861 that each extend from an outer surface 1862 to an inner surface 1863 and from a top end surface 1864 to a bottom end surface 1865. The intersection of the inner surface 1863 with the top end surface 1864 forms a top wedge 1868 and the intersection of the inner surface 1863 with the bottom end surface 1865 forms a bottom wedge 1866. Thus, the top wedge 1868 and the bottom wedge 1866 cooperatively define a C-shaped configuration. The top wedge 1868 is generally configured to extend over and mate with the top outer surface 1846 of the strike ring 1840 while the bottom wedge 1866 sits on the flange 1804 of the support sleeve 1802, between an upper ledge 1805 of the flange 1804 and an overhang 1810 that extends over the upper ledge 1805 of the flange 1804. At the same time, the inner surface 1863 of each of the multiple pieces 1861 of the coupling ring 1860 mates with outer surface 1847 of the strike ring 1840 and the overhang 1810. Put simply, each of the multiple pieces 1861 of the coupling ring 1860 is carefully dimensioned to extend around the top outer surface 1846 and the outer surface 1847 of the strike ring 1840 and the overhang 1810 of the support sleeve 1802 to capture the strike ring 1840 and the support sleeve 1802 and clamp these two components together.

The cover ring 1880 also includes a main body 1881 that extends from an outer surface 1882 to an inner surface 1883 and from a top end surface 1884 to a bottom end surface 1885. A bottom end of the cover ring 1880 (e.g., a portion proximate bottom end surface 1885) is relatively rectangular and is configured to be placed against the upper ledge 1805 of the support sleeve 1802. Therefore, the coupling ring 1860 and the cover ring 1880 cooperatively cover the upper ledge 1805 to block exposure of the upper ledge 1805 to a valve component. Meanwhile, the inner surface 1883 extends along and around the outer surface 1862 of the coupling ring 1860, and the top end surface 1884 includes an inwardly extending covering flange 1888 that extends over a top end surface 1864 of the coupling ring 1860, towards the top inner surface 1844 of the strike ring 1840. In fact, since the top inner surface 1844 of the strike ring 1840 is tapered and configured to define at least a portion of a strike surface of the valve seat assembly 1800, a top inner surface 1849 of the flange 1888 may have a similar taper to extend the strike surface in a relatively continuous manner. That is, the top inner surface 1844 of the strike ring 1840 and the top inner surface 1849 of the flange 1888 may extend collinear to one another. However, regardless of the shape of the flange 1888, since the flange 1888 extends over the top end surface 1864 of the multiple pieces 1861 of the coupling ring 1860, the cover ring 1880 pushes and/or compresses the coupling ring 1860 and strike ring interiorly as the cover ring 1880 slides into place between the coupling ring 1860 and the walls of the fluid end casing forming a fluid end bore. In turn, this locks the coupling ring 1860 in place around the strike ring 1840 and against the overhang 1810 of the support sleeve 1802. Thus, the hard material of the strike ring 1840 is adequately secured in place atop of the support sleeve 1802, so that the hard material of the strike ring 1840 can receive wear from repeated interactions with the valve (via its strike surface) without directly transferring this wear to the fluid end casing (due to the support sleeve 1802, the coupling ring 1860, and the cover ring 1880 being interposed therebetween).

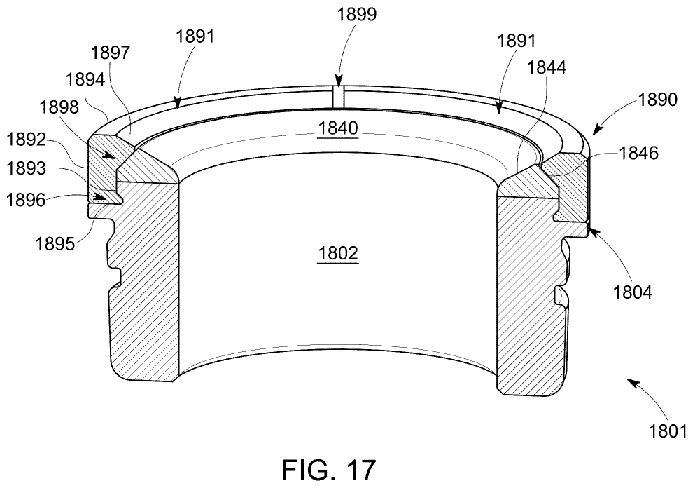

FIG. 17 depicts a valve seat assembly 1801 that is substantially similar to valve seat assembly 1800; however, now, the valve seat assembly 1801 couples the strike ring 1840 to the support sleeve 1802 with a coupling cover ring 1890. In the depicted embodiment, the coupling cover ring 1890 includes multiple pieces 1891 collectively defining an annular ring shape and having an overall geometry that is similar to the combined geometries of the coupling ring 1860 and the cover ring 1880. The multiple pieces 1891 are coupled to each other with mechanical couplings 1899, such as clamps, bolts, etc. Each of the pieces 1891 extends from an outer surface 1892 to an inner surface 1893 and from a top end surface 1894 to a bottom end surface 1895, which is configured to engage the upper ledge 1805 of the support sleeve 1802 to block exposure of the upper ledge 1805 to a valve component. The intersection of the inner surface 1893 with the top end surface 1894 forms a top wedge 1898 and a covering flange 1897. The intersection of the inner surface 1893 with the bottom end surface 1895 forms a bottom wedge 1896. Wedges 1896 and 1898 function in a similar manner to wedges 1868 and 1866 of coupling ring 1860 and, thus, any description of wedges 1868 and 1866 should be understood to apply to wedges 1896 and 1898. Similarly, covering flange 1897 functions in a similar manner to covering flange 1888 of cover ring 1880 and any description of flange 1888 should be understood to apply to covering flange 1897. In other words, the coupling cover ring 1890 functions as both the coupling ring 1860 and the cover ring 1880 of the valve seat assembly 1800 and therefore may reduce a total quantity of components used to provide the valve seat assembly 1801 (e.g., as compared to for the valve seat assembly 1800).

In the embodiment of FIGS. 15 and 16, the pieces 1861 of the coupling ring 1860 are small to facilitate insertion of these pieces into a relatively small gap between the support sleeve 1802 and the fluid end. However, the coupling ring 1860 is still provided in pieces to ensure that the pieces 1861 can fit around the overhang 1810 and the strike ring 1840. However, in some embodiments, it might be possible to limit the number of pieces needed since the space filled by the cover ring 1880 provides some room for manipulation. By comparison, in FIG. 9, the coupling cover ring 1890 is again provided in pieces to fit within the relatively tight tolerances between the fluid end casing and the support sleeve (e.g., to get around overhang 1810). That being said, in some embodiments, the coupling cover ring 1890 may include a single, integral (e.g., monolithic) piece.

Referring again to all of FIGS. 15-17, in these embodiments, the additional components can be formed of any desired material, e.g., to minimize costs of manufacturing and/or for the end user. For example, the coupling ring 1860, the cover ring 1880, and/or the coupling cover ring 1890 may be formed from the same material as that of support sleeve 1802 and/or from a material that is not as hard as support sleeve 1802. For example, one or more of the coupling ring 1860, the cover ring 1880, and the coupling cover ring 1890 may be formed from a steel formulation that is less expensive than a steel or carbide formulation used to manufacture the strike ring 1840. Notably, the exterior portion of a valve is often wrapped with a seal or other material that dampens the impact force as compared to the force imparted by an interior, harder part of the valve (often formed from steel). Thus, even if a small portion of the cover ring 1880 and/or the coupling cover ring 1890 defines a part of a strike surface impacted by a valve (e.g., the dampening material) during closure of the valve assembly, the cover ring 1880 and/or the coupling cover ring 1890 can often be formed from a relatively softer material as compared to the material used for strike ring 1840 without negatively impacting performance or longevity of its valve seat assembly.

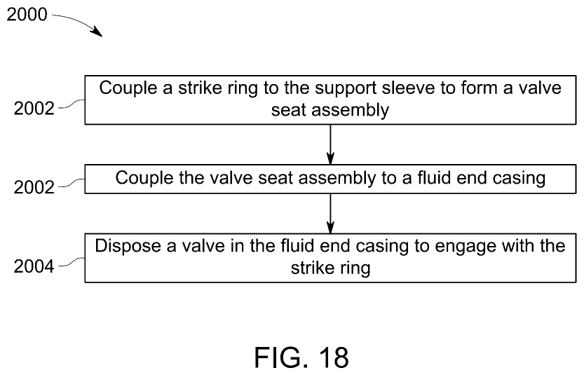

FIG. 18 is a flowchart of a method 2000 of manufacture of a fluid end. It should be noted that the method 2000 may be performed differently than depicted. For example, an additional operation may be performed, and/or any of the depicted operations may be performed differently, performed in a different order, and/or not performed.

At block 2002, a strike ring is coupled to a sleeve to form a valve seat assembly. In some embodiments, the strike ring and the support sleeve have corresponding mating features to couple to one another. As an example, the mating features may include interlocking wedge mating features. As another example, the mating features may include corresponding convex and concave surfaces. As a further example, the mating features may include corresponding male and female mating features. In any case, the mating features provide multiple joints extending in different directions to block relative movement between the support sleeve and the strike plate in multiple directions (e.g., along multiple degrees of freedom) to secure the support sleeve and the strike plate to one another. In additional or alternative embodiments, an additional component may help couple the strike ring and the support sleeve to one another. By way of example, a ring (e.g., a coupling ring, a cover ring, a combined coupling cover ring) may compress the support sleeve and the strike plate against one another. In certain implementations, coupling the strike ring to the support sleeve covers a surface (e.g., a surface at which the mating feature is formed) of the support sleeve. In any case, coupling the strike ring to the support sleeve forms a valve seat assembly.

At block 2002, the valve seat assembly is coupled to a fluid end casing of the fluid end. For instance, the support sleeve may be inserted into a bore defined by the fluid end casing such that the support sleeve engages with a wall section of the fluid end casing. That is, the support sleeve is pressed into the bore to secure the support sleeve within the bore. Additionally, the support sleeve limits contact between the strike ring and the fluid end casing.

At block 2004, a valve is disposed in the fluid end casing to engage with the strike ring. In particular, the strike ring defines a strike surface configured to engage with a corresponding strike surface of the valve to block fluid flow through the bore (e.g., through the valve assembly). During operation of the fluid end, the valve may repeatedly move into and out of contact with the strike surface to selectively enable and block fluid flow through the bore. The strike ring is composed of a sufficiently hard material, such as a carbide material, to withstand forces imparted by the valve during impact with the strike surface of the strike ring. That is, the sufficiently hard material of the strike surface limits wear caused by the valve repeatedly striking the strike surface. Meanwhile, the support sleeve is composed of a relatively soft material. However, because the strike ring covers a surface of the support sleeve, the strike ring blocks the surface from contacting the valve, thereby avoiding wear of the support sleeve from impact with the valve. Additionally, because the support sleeve limits contact between the strike ring and the fluid end casing, the support sleeve reduces wear of the fluid end casing that otherwise may occur when the fluid end casing contacts a harder material (e.g., the material of the strike ring). Therefore, the support sleeve may act as a wear interface to block wear or forces from transferring from the strike ring to the fluid end casing during impact between the valve and the strike ring.

While the apparatuses presented herein have been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. For example, the valve components, valve body, the valve seat assembly components, the valve seat, the support sleeve, and sealing elements described herein may be modified to be of any shape and of any material.

In addition, various features from one of the embodiments may be incorporated into another of the embodiments. That is, it is believed that the disclosure set forth above encompasses multiple distinct inventions with independent utility. For example, a valve seat might include a wedge joint and a non-arcuate joint, a wedge joint and an extension-groove arrangement, etc. Moreover, while each of these inventions has been disclosed in a preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising,” etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about,” “around,” “generally,” and “substantially.”

What is claimed is:

1. A valve seat assembly for a reciprocating pump, the valve seat assembly comprising:
a support sleeve configured to couple to a fluid end casing of the reciprocating pump at a fluid end bore of the reciprocating pump, wherein the support sleeve comprises a first surface with a first mating feature; and
a strike ring configured to engage with a valve to block fluid flow through the fluid end bore, wherein the strike ring comprises a second surface with a second mating feature configured to mate with the first mating feature of the support sleeve to couple to the support sleeve, and the second surface covers the first surface while the support sleeve and the strike ring are coupled to one another to block exposure of the first surface to the valve.

2. The valve seat assembly of claim 1, wherein the support sleeve is composed of a first material, and the strike ring is composed of a second material, harder than the first material.

3. The valve seat assembly of claim 2, wherein the second material comprises a carbide material.

4. The valve seat assembly of claim 1, wherein the support sleeve is configured to block contact between a radially extending surface of the strike ring and the fluid end casing.

5. The valve seat assembly of claim 1, wherein the strike ring is configured to engage with the support sleeve at a plurality of joints via the first mating feature and the second mating feature to couple to the support sleeve, wherein a first joint of the plurality of joints extends along a central axis of the fluid end bore and a second joint of the plurality of joints extends transverse to the central axis to block relative movement between the support sleeve and the strike ring along a plurality of directions.

6. The valve seat assembly of claim 1, wherein the first mating feature of the support sleeve comprises a groove, and the second mating feature of the strike ring is configured to insert into the groove to couple the strike ring to the support sleeve.

7. The valve seat assembly of claim 1, wherein the first mating feature of the support sleeve comprises an extension, and the second mating feature of the strike ring is configured to receive the extension to couple the strike ring to the support sleeve.

8. The valve seat assembly of claim 1, wherein one of the first mating feature of the support sleeve or the second mating feature of the strike ring includes a convex surface, the other of the first mating feature or the second mating feature includes a concave surface, and the convex surface and the concave surface are configured to engage with one another to couple the strike ring to the support sleeve.

9. The valve seat assembly of claim 1, wherein the first mating feature of the support sleeve and the second mating feature of the strike ring comprise corresponding wedge mating features configured to interlock with one another to couple the strike ring to the support sleeve.

10. The valve seat assembly of claim 1, wherein the strike ring comprises a third surface, opposite the first surface, configured to engage with the valve to block fluid flow through the fluid end bore, and the third surface is angled with respect to the first surface.

11. A valve seat assembly for a reciprocating pump, the valve seat assembly comprising:
a support sleeve configured to couple to a fluid end casing of the reciprocating pump to extend at least partially into a fluid end bore of the reciprocating pump;
a strike ring configured to engage with a strike surface of a valve to block fluid flow through the fluid end bore, wherein the strike ring is configured to abut the support sleeve; and
a coupling ring configured to clamp the support sleeve and the strike ring to one another, wherein the strike ring and the coupling ring block contact between the support sleeve and the strike surface of the valve while the support sleeve, the strike ring, and the coupling ring are coupled to one another.

12. The valve seat assembly of claim 11, wherein the strike ring is composed of a material that is harder than that of the support sleeve.

13. The valve seat assembly of claim 12, wherein the support sleeve is composed of steel.

14. The valve seat assembly of claim 11, comprising a cover ring configured to engage with the fluid end casing to compress against the coupling ring to cause the coupling ring to clamp the support sleeve and the strike ring to one another.

15. The valve seat assembly of claim 11, wherein the support sleeve is configured to block contact between the strike ring and the fluid end casing.

16. A valve seat assembly for a reciprocating pump, the valve seat assembly comprising:
a support sleeve configured to couple to a fluid end casing of the reciprocating pump, wherein the support sleeve defines at least a portion of a bore through which fluid may flow, and the support sleeve comprises a first mating feature; and
a strike ring configured to engage a strike surface of a valve to block fluid flow through the bore, wherein the strike ring comprises a second mating feature configured to mate with the first mating feature of the support sleeve to couple to the support sleeve, the strike ring is configured to block contact between the strike surface of the valve and the support sleeve while the support sleeve and the strike ring are coupled to one another, and the support sleeve is configured to block contact between the strike ring and the fluid end casing while the support sleeve and the strike ring are coupled to one another.

17. The valve seat assembly of claim 16, wherein the strike ring comprises a first surface comprising the second mating feature and a second surface, opposite the first surface, configured to engage the strike surface of the valve.

18. The valve seat assembly of claim 17, wherein the strike ring comprises an inner surface defining at least another portion of the bore, and the second surface is angled with respect to the inner surface.

19. The valve seat assembly of claim 16, wherein the second mating feature of the strike ring comprises a protrusion, and the first mating feature of the support sleeve is configured to receive the protrusion to couple the strike ring to the support sleeve.

20. The valve seat assembly of claim 16, wherein the strike ring terminates prior to the bore defined by the support sleeve.
